(19) United States
(12) Patent Application Publication
(10) Pub. No.: US 2017/0339256 A1
(43) Pub. Date: Nov. 23, 2017

(54) ABSTRACTION LAYER FOR COMMUNICATION METHODS

(71) Applicant: MARTIN WIELAND, MUNICH (DE)

(72) Inventor: MARTIN WIELAND, MUNICH (DE)

(21) Appl. No.: 15/156,433

(22) Filed: May 17, 2016

(51) Int. Cl. H04L 29/06; G06F 17/30

(52) U.S. Cl. CPC H04L 69/08; G06F 17/30545

(57) ABSTRACT

A method and apparatus of performing bidirectional data transmission between electronic devices or its components that use different communication methods (CM) is disclosed. Output and/or input of the CMs used by the participating devices or its components to/from components other than the CMs itself is mediated by an abstraction layer (AL) which in turn presents an abstract interface that allows reading and writing from/to the participating CMs and thus the devices or its components. Data in an output area of a CM is read by the AL, translated into input data understandable by a different CM and sent to the input area of the different CM. The invention enables bidirectional communication between devices or its components that use different CMs without the need for knowledge of the communication protocols of the CMs or modifications of the CMs, the participating devices or its components.

### TECHNICAL FIELD OF THE INVENTION

This invention relates to bidirectional transmission of data between electronic devices and/or its components, and more particularly to providing access to, translation, sending and reception of data created and/or used by different communication methods.

### BACKGROUND OF THE INVENTION

Per definition the Internet of Things (IoT) is a network of physical objects or “things” embedded with electronics, software, sensors, and network connectivity, which enables these objects to collect and exchange data. The IoT allows objects to be sensed and controlled remotely across existing network infrastructure, creating opportunities for more direct integration between the physical world and computer-based systems, and resulting in improved efficiency, accuracy and economic benefit.

In case the IoT is augmented with sensors and actuators, the technology becomes an instance of the more general class of cyber-physical systems, which also encompasses technologies such as smart grids, smart homes, intelligent transportation and smart cities. Each thing in the IoT is uniquely identifiable through its embedded computing system but is able to interoperate within the existing Internet infrastructure.

The term was already coined in the late nineties when developers worked on a project to create a global network of Radio-frequency identification (RFID) connected objects.

Typically, IoT is expected to offer advanced connectivity of devices, systems, and services that goes beyond machine-to-machine communications (M2M) and covers a variety of protocols, domains, and applications. The interconnection of these embedded devices (including smart objects), is expected to usher in automation in nearly all fields, while also enabling advanced applications like a Smart Grid, and expanding to the areas such as smart cities.

“Things”, in the IoT sense, can refer to a wide variety of devices such as heart monitoring implants, biochip transponders on farm animals, electric clams in coastal waters, automobiles with built-in sensors, DNA analysis devices for environmental/food/pathogen monitoring or field operation devices that assist in search and rescue operations. These devices collect useful data with the help of various existing technologies and then autonomously flow the data between other devices. Current market examples include smart thermostat systems and washer/dryers that use Wi-Fi for remote monitoring.

Besides the plethora of new application areas for Internet connected automation to expand into, IoT is also expected to generate large amounts of data from diverse locations that is aggregated very quickly, thereby increasing the need to better index, store and process such data.

The IoT will also be especially important in manufacturing. The number of networked sensors is already growing dramatically across production helping manufacturing companies improve operations and enforce measures for transparency, cost reductions and quality improvements. With the IoT technologies are coming together, making it possible to connect and control nearly everything in real-time to make smarter decisions. According to experts, the IoT already is the merger of information and manufacturing technologies.

However, the above statements currently are only true for devices that are connected by a communication network and use or understand the communication protocol used by all other participating devices, typically IT devices like PC's, tablet computers or smart phones or autonomous networked sensors.

At least at the time of writing, the vast majority of devices that are able to perform physical actions such as machines or cars which may lead to injuries of persons or any other damages does not participate in the IoT. Due to reasonable security, indemnification and warranty concerns the majority of these devices can neither be accessed nor controlled or steered by external devices that try to access them via known communication protocols used for communication between IT devices. For communication with and control of such devices from external devices several technologies are known in the art. Most of these techniques have in common that they utilize manufacturer specific, proprietary communication protocols that require the participating devices to use the same method.

It is known in the art that an electronical device can be connected to a remote electronical device which also may be a technical device (e.g. a machine, car or sensor) in case both devices use the same transport medium and transport protocol or a bridging technology (e.g. a router) that interconnects different transport mediums and transport protocols. The electronical devices can communicate with each other if both devices are connected to each other and are equipped with logic to understand data sent by the other device, a communication protocol. In this case both parties utilize the same communication method (hereafter called CM or CMs) they have a common CM, speak the same “language”. If the electronical device then sends data to the remote device the receiving device may perform actions.

If the electronical device receives data from a remote device the common CM is able to understand the data and can perform actions at the receiver. It is usually possible that, on reception of data, the common CM outputs data to other components like peripheral devices or programs at the local or even another remote electronical device which then also perform actions e.g. store or output data. To do so the CM has to contain the required logic, know the output components and send data in a format understandable by them.

Typically CMs also are able to accept and receive input data from such other components at the local or even another remote electronical device. On reception of input data the CM can communicate with a remote device which may cause the remote device to perform actions. This also requires that the CM contains the logic to do so, knows the input components and understands its data.

Data from a remote device received by the local device via the common CM of both devices cannot be output to such other components if these components are not known by the common CM. Input components of a local device which target a different CM or are not known by the common CM of both, local and remote device cannot communicate with the remote device. Components on a remote device cannot communicate with a local device that does not use the CM of these components because the local device can either not be reached at all or, in case it can be reached, the local device does not understand the data. If the CM of a device is not configured to accept input and understand the CM of a different component actions performed by the different component have no effect. If the CM of a device is not configured to output data to a different component in a way so that the different component is able to understand it output of data from the CM to the different component also has no effect.

So, how can a local device or its components that use a CM not known by or different to the CM used by the remote device or its components, be able to send or receive data to/from the remote device in a way so that the receiving device understands it and may perform actions?

One of the oldest and best known solutions in the art is to add an additional electronical device (e.g. a Programmable Logic Controller hereafter called PLC) to the remote device that is equipped with digital and/or analog inputs or outputs which are connected to analog and/or digital in- or outputs of the remote device. The additional device is connected to and communicates with the local device by using a common CM. Data received by digital or analog inputs of the additional device is translated into data understandable for the local device and sent to the local device. Data from the local device designated for the remote device is sent to the additional device which, on reception analyzes the data and switches digital outputs on or off or sets voltage, current or amperage of an analog output to a specific level. This may cause the remote device to perform actions. Apart from the limited possible actions that can be performed this way and the effort to find appropriate digital or analog interfaces on the remote device it has to be taken into account that an additional network connection is needed although the remote device itself may already have one. The need for a common CM between additional and local device in most cases requires additional logic at the local device which may not be desirable.

For remote devices that are equipped with a PLC a variant of the technique described above is known where, instead of digital and/or analog in- and outputs (hereafter called I/O) at the additional device a direct connection to the PLC of the remote device is used. Although this removes the limitations caused by usage of analog and digital I/O's it has to be taken into account that, apart from the need for a communication interface at the PLC of the remote device, knowledge and implementation of the internal protocol used by the PLC of the remote device is needed at the additional device.

Another, meanwhile also well-known approach for remote devices that already have a network connection is to add another CM (e.g. an OPC Server or Client) to the remote device that is understood by the local device. In case the remote device is able to interact with the additional CM it is possible to read data from and write data to the remote device by using the same CM on the local device. This solution requires modifications of the remote device which may not be possible due to technical limitations, restrictions by the manufacturer of the device, high implementation costs or concerns about functionality or warranty.

One of the newer solutions known in the art is to add a program, hereafter called agent, to the remote device that communicates with components of the remote device by using the internal communication protocol of the remote device and translates this data into data understood by the local device and transport it to the local device by using a common CM understood by the local device. Commands from the local device to the remote device are received by the agent, translated into the internal communication protocol of the remote device and may cause the remote device to perform actions. In this case again the remote device has to be modified, it may not be possible to add or run an agent at the remote device and the remote device has to be able to transfer data in the way needed by the additional CM used by the agent. Also the local device in most cases has to be equipped with additional logic to be able to communicate with the agent. For example U.S. Pat. No. 7,831,752 adds additional logic to devices that enables them to exchange data with a large variety of other devices. However, this requires modifying the participating devices.

Another solution meanwhile known in the art called “MTConnect” was created 2008. The technology is based on the usage of “adapters” which are programs installed on a computer that communicate with a remote device by using the CM of the remote device for example a manufacturer specific protocol. Data acquired from a remote device is translated into a standardized data format by the adapter. The adapter's data is queried by an “agent” which communicates with the adapter via http TCP/IP protocol. The agent's data can be accessed by IT devices without the need for manufacturer specific CMs. Although this technique offers advantages over other solutions several requirements have to be met and restrictions apply. As the adapter is installed on a computer, remote device and computer need to be connected to each other by a communication network and be able to communicate with each other by a common CM. The manufacturer specific protocol used between adapter and remote device has to be known and able to be used on a computer. For communication between agent and adapter a fixed CM has to be used.

It is also possible and known in the art to add additional logic to the local device that is able to communicate with the remote device by using the CM of the remote device and read data from and write data to internal components of the remote device. Incoming data from the remote device is received by the additional CM at the local device and translated into data understandable by the local device. Data from the local device to the remote device is translated and passed to the additional CM at the local device which then sends commands to the remote device. For this solution the logic of the CM of the remote device has to be available, known and added to the local device. The local device has to be able to directly communicate with the remote device in the way required by the remote device.

U.S. Pat. No. 8,352,536 discloses a technique that enables communication of multiple automation systems (ATK) which utilize different communication protocols with a production management system. The invention provides various ways to convert data from the ATK's proprietary protocols into a data format understandable by a production management system. However, the technique mandatorily requires components (GDS) which are directly connected to each automation system and are able to communicate with each automation system by having implemented and using the communication protocol of each automation system.

Document U.S. Pat. No. 6,298,377 discloses a method to collect status and/or diagnostic data of field devices over a field communication interface in a manner specific for each type of field device. Although conversion of data from different communication protocols into a single data format is disclosed components that have the communication protocol of the field bus devices implemented and understand it are required.

U.S. Pat. No. 6,397,225 discloses a messaging system with protocol independent message format which includes various pieces of manufacturing equipment that are coupled to a message bus for exchanging information. An equipment interface presents a consistent interface to the message bus, independent of the particular function of the manufacturing equipment. The equipment interface translates the protocol of the manufacturing equipment to a format compatible with other devices on the message bus. The equipment interface is a software program running on a computer that is coupled to the manufacturing equipment through a physical connection. The equipment interface presents a consistent interface to the message bus, independent of the particular function of the manufacturing equipment. The equipment interface translates the protocol of the manufacturing equipment to a format compatible with other devices on the message bus. Thus, other devices in the factory system need not necessarily know the specific protocol of the manufacturing equipment. Although the method enables communication between devices with different communication protocols there are several disadvantages. The equipment interface has to have the communication protocol of the manufacturing equipment implemented; it has to translate this information into a single data format; data to be sent to another manufacturing equipment has to be translated by an equipment interface from this data format into the proprietary communication protocol of the equipment which again requires knowledge and implementation of the protocol.

U.S. Pat. No. 7,870,275 also discloses a communication scheme-independent infrastructure that enables communication between components which use different communication protocols. However, each component in this solution has to communicate with a server and exchange data with this server to obtain information required to communicate with another component. This mandatorily requires modifying all participating components which in most cases is not possible.

U.S. Pat. No. 6,829,288 discloses a communication system having wireless devices supporting ad hoc connections independent of the protocol version. The technique includes identification of a communication protocol used by a device, extraction and insertion of data into a different protocol and transmission of the data. However, for this technique to work the communication protocols of all participating devices have to be known and implemented at the device that performs protocol conversion.

Methods for data conversion between different formats or communication protocols such as A/D converters (ADC) or text to speech converters are generally known in the art. These techniques have in common that data from a known, expected format or communication protocol is converted into a different format or communication protocol by applying conversion rules on input data followed by output of the result. This requires that the input and output formats or communication protocols are known by and implemented in the conversion method. For devices with non-disclosed communication protocols this may not be possible.

Although various methods that allow exchange of data between devices that do not have a common CM are known and disclosed in detail all known techniques do not address the problem on how to successfully establish bidirectional communication between devices that do not have a common CM without the need to know and implement the communication protocols of the participating CMs, add hardware or modify at least one of the participating devices by changing an existing CM or adding an additional one.

### SUMMARY OF THE INVENTION

A method and apparatus of performing bidirectional data transmission between electronic devices or its components that use different communication methods (CM) is disclosed. Output and/or input of the CMs used by the participating devices or its components to/from components other than the CMs itself is mediated by an abstraction layer (AL) which in turn presents an abstract interface that allows reading and writing from/to the participating CMs and thus the devices or its components. Data in an output area of a CM is read by the AL, translated into input data understandable by a different CM and sent to the input area of the different CM. The invention enables bidirectional communication between devices or its components that use different CMs without the need for knowledge of the communication protocols of the CMs or modifications of the CMs, the participating devices or its components.

### BRIEF DESCRIPTION OF THE FIGURES

FIG. 1 is an exemplary illustration generally representing devices such as computers and various technical devices connected by communication networks, according to example embodiments of the present invention.

FIG. 2 is a block diagram that shows the architecture and mandatory and optional components of an AL for CMs.

FIG. 3 is a block diagram that shows multiple devices which utilize different CMs and their possible interconnection by AL objects.

FIG. 4 is a block diagram depicting possible locations of input or output areas of AL objects on local or remoted devices.

FIG. 5 is a flow chart that depicts acquisition and processing of data in so called “unsolicited mode”.

FIG. 6 is a flow chart showing additional steps that may be performed by the invention in case “solicited mode” is used.

FIG. 7 is a block diagram that depicts a practical example of communication between cars from different manufacturers according to possible embodiments of the disclosed invention.

FIG. 8 is a block diagram showing an example embodiment of the invention that enables monitoring of glucose sensors and control of insulin pumps from different manufacturers.

### DETAILED DESCRIPTION OF THE INVENTION

It will be readily understood that the components of the present invention, as generally described and illustrated in the figures herein, may be arranged and designed in a wide variety of different configurations. Thus, the following detailed description of the embodiments of a method and apparatus as represented in the attached figures, is not intended to limit the scope of the invention as claimed, but is merely representative of selected embodiments of the invention. The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

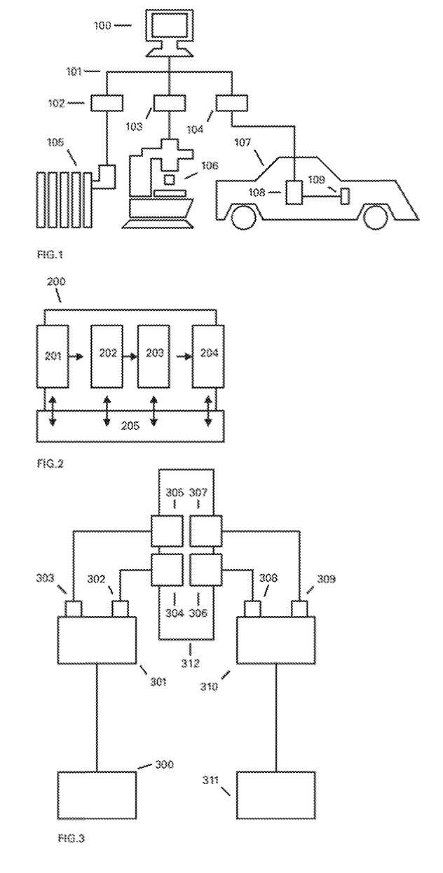

FIG. 1 shows an exemplary illustration generally representing devices such as computers and various technical devices connected by communication networks according to example embodiments of the present invention. Computer 100 is connected to communication network 101. It may be possible to send and receive data to and from other nodes connected to this network in case the nodes use the same CM as the computer. A technical device, for example a radiator 105 is connected to electronical device 102 by a manufacturer specific connection, which may be a communication network, that uses a proprietary CM to exchange data between the radiator and the electronical device. The electronic device may also be connected to the communication network used by computer. In case both devices, computer and electronic device use a common CM it is possible to exchange data between the devices. However, as the radiator uses a manufacturer specific CM the computer cannot directly communicate with it. Another technical device, in this example a manufacturing machine 106 may be connected to the communication network used by the computer. If the manufacturing machine cannot be connected to the communication network it may be possible to connect it to an interposed electronic device 103 which, on the one hand communicates with the manufacturing machine by again using a manufacturer specific CM and, on the other hand communicates with the computer by using a common CM. Another technical device, in this example a car 107 may be connected to the communication network by using an additional electronical device, for example a computer or a smartphone 108. This device may be able to exchange data with internal components of the car by a manufacturer specific connection with a proprietary communication protocol to, for example the diagnostic connector 109 of the car.

In FIG. 2 a block diagram is shown that depicts a possible architecture of an object that is part of an AL for CMs and its mandatory as well as optional components. The object 200 mandatorily consists of at least one input area 201 for data, at least one input 202 and at least one output section 203 and at least one output area 204 for data. Optionally, but highly recommended, the object may be equipped with a communication component 205 that allows interaction with or modification of the content of one or more components for example by reading one or more configuration files or by providing access to or from external components, devices or data sources. Input and output sections of an AL object, their content, their relationships and the relationships of their entries can be created, configured and used in various forms. In a very simple embodiment an input and output section could be created as lists with one column that contain one entry per row. An entry could, for example contain data such as a command. The relationship between the entries in both sections could be defined as their position in the column. In other possible embodiments each section could be created as lists with multiple columns. Each column of such a list could contain different items for example an identifier for the entry, one or more commands, identifiers for rows in corresponding sections, definitions of associated input and output areas, rules for comparing data and so on. In any case the sections contain information that enables the AL object to decide what to do with incoming or outgoing data. An input section of an AL object contains data used for comparison with raw or processed data from an input area of the AL object. Input and output areas of an AL object can also be created, configured and used in various forms. In a simple example an input and output area could be configured as memory address ranges of a remote electronical device which is accessible by a CM of the device with the AL object. Whenever data arrives or changes in this input area it may be processed and compared with entries in an AL object's input section. Data from an output section could be processed and sent to a defined memory address range of the remote device. In another possible embodiment input and/or output areas could be defined as a memory address ranges of a device with an AL object wherein the address ranges could be associated with CMs of the device for example an http, ftp or a manufacturer specific service. In another possible embodiment these areas could also be defined as memory address ranges which are assigned to input or output areas of a peripheral device of the device for example a serial interface or a communication interface. Input and output areas could also be configured as separate storage locations that, in case of an input area could be filled with data from an interception technique or, in case of an output area, can be read by a CM of a remote device. If necessary, data acquired from an input area can be processed in various ways before it gets compared with entries in an AL objects input section. If, for example just a subset of the incoming data should be compared unnecessary data such as protocol overhead could be removed by just looking at data within specified ranges or data delimited with specified identifiers. Another possible way to process input data would be to store the data or parts of it and use it for mathematical operations, comparison or combination with previous or subsequent data. Data from an output section designated for an output area can also be processed in various ways before transmission for example by adding protocol specific information required by a receiving CM. Of course it would also be possible to store output data for mathematical operations, comparison or combination with previous or subsequent data.

An AL object's input section may have one or more corresponding entries in an AL object's output section which contains data that may be sent to an output area of the AL object. Each entry in both, input and output section may have different input and output areas associated with it. Various relationships between entries in the input and output section are possible, for example one entry in the input section can point to a single or multiple entries in the output section or multiple entries in the input section can point to a single entry in the output section. A single AL may contain multiple AL objects wherein each object can be configured in a different manner and may be responsible for communication with one or between different CMs. An input area of an AL object contains data output by a CM and may be an output area of a CM or a separate area that contains output data of the CM.

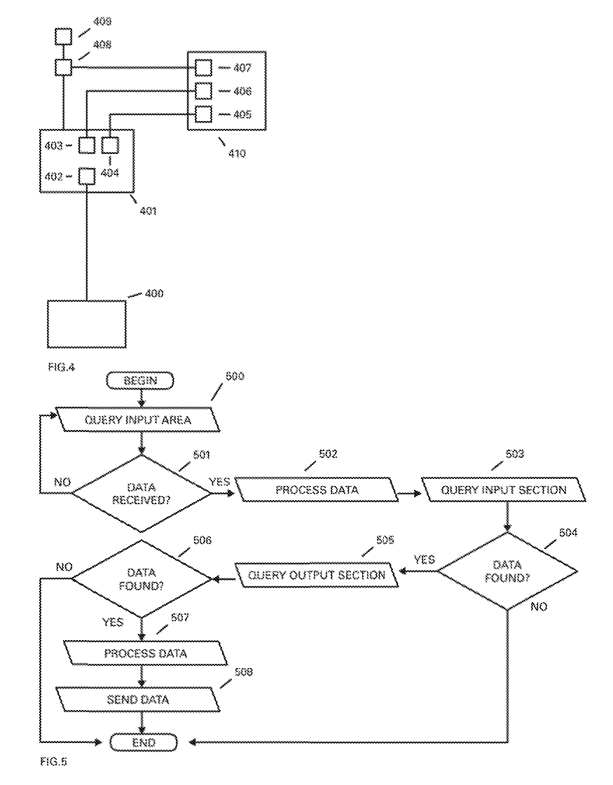

In FIG. 3 a block diagram of an exemplary embodiment is shown that contains multiple devices which utilize different CMs and their possible interconnection by AL objects. Remote device A 300 is connected to local device A 301 by a communication network. Both devices use a common first CM with at least one input 302 and output area 303. In this example one output section 304 of AL object 312 uses the first CMs input area as its output area and the first CMs output area as its input area 305. Input section 305 may point to output section 307 which uses the input area 309 of a secondary CM as its output area. The secondary CM is used by local device B 310 and remote device B 311 which are also connected by a communication network. The output area 308 of the secondary CM is used as input area for the AL objects input section 306. Each input section may point to an output section of an AL object. If data arrives in the output section of the first CM the AL object could process and compare the data with entries in an input section and in case at least one entry is found optionally process and send data from an output section associated with the entry in the input section to the input area of a secondary CM. Data written to the input area of the secondary CM could cause local device B to communicate with remote device B and instruct it to perform actions. If such an action causes data to be written to the output area of the secondary CM the information could be read by the AL object, optionally be processed and compared with entries in an input section and could cause data from an associated output section to be written to the input area of the first CM.

FIG. 4 shows possible locations of input or output (I/O) areas of AL objects. A local device 401 communicates with remote device 400 by using a common CM of both devices. In case the local device can be accessed from a device 410 with an AL object by using a communication network the I/O area 402 of the CM could directly be used as I/O area of an AL object. If a device with an AL object can be connected to the local device by using a peripheral device e.g. a serial interface and the CM utilizes the I/O area 404 of the peripheral device for communication either this area or the I/O area 405 of the peripheral device at the device with an AL object can be used as I/O areas for AL objects. If the CM outputs data to a memory location 403 e.g. a file at the local device or to a memory location 406 of a device with an AL object these areas also can be used as I/O areas for an AL object. If the CM of the local device communicates with another remote device 409 and data traffic between these devices can be intercepted and stored at a device with an AL object it also can be used as I/O area 407 for an AL object.

Data in an input area may be read by an AL object in either “unsolicited” or “solicited mode”. In “unsolicited mode” the CM automatically delivers output data which may be an AL object's input area whereas in “solicited mode” the CM has to be instructed to query data and deliver it to its output area.

To acquire data from a CM in “unsolicited mode” the AL object monitors an input area and listens for incoming data. On reception of data the AL object processes and compares the received data with content in its input section and may process and send corresponding data in its output section to an output area which may be an input area of a CM or a separate area that contains input data of a CM. FIG. 5 depicts the process of data acquisition and processing in this mode. The AL object queries 500 an input area for data. If the result of the query 501 reports no data the task may be repeated until data is found. If data is found it can be processed 502 for example by adding data, stripping off parts of the data storing the data or parts of it and use it for mathematical operations, comparison or combination with previous or subsequent data. Raw or processed input data then can be used to query the input section for matching entries 503, for example data or a command, by comparing the input data with entries in the input section. If at least one entry is found 504 the output section of the AL object may be queried for corresponding entries 505. If at least one entry is found 506 the content of the output section may be processed 507, for example by adding data, storing the data and use it for mathematical operations, comparison or combination with previous or subsequent data. Raw or processed data then can be sent 508 to the output area of the AL object. In other example embodiments of the invention it is also possible that the steps of querying the input and output section are repeated until no more matching entries are found (not shown).

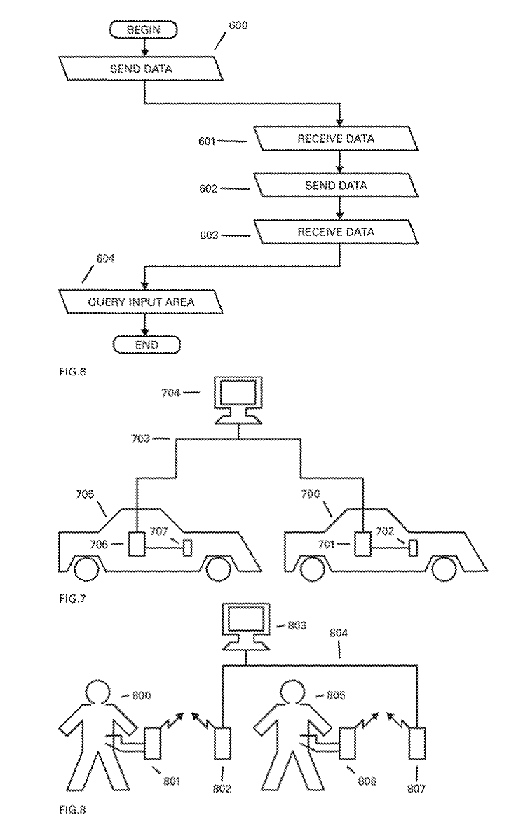

To get data from the CM in “solicited mode” the AL object first sends data, for example one or more commands to an output area which, in this case can be configured to point to the input area of the CM. Data to be sent to the output area of the CM can either be one or more entries in the output section of the AL object or directly be received by a communication component of the AL object. In case data from an output section is used it can be selected by corresponding entries in the input section of the AL object. Reception of such data in its input area causes the CM to query the remote device for data which then arrives in the output area of the CM where it can be read and processed by the AL object according to the description above. FIG. 6 depicts possible additional steps performed if this method is used. The AL object sends 600 data to the input area of a CM. Reception 601 of data in this area causes the CM to send 602 the data to the remote device. Data received 603 from the remote device is written to the output area of the CM which is queried 604 and processed by the AL object as depicted in FIG. 5 and described above.

In FIG. 7 a block diagram is shown that depicts a practical example of communication between cars from different manufacturers by using AL objects. A first car 700 is equipped with an on board diagnosis (OBD) interface device 702 that is connected to an electronical device 701 for example a smartphone via an USB cable. The electronical device has a manufacturer specific software program installed that exchanges data with the OBD interface by using an undisclosed manufacturer specific communication protocol, enables the user to manually input data, sends commands to the OBD interface, outputs data received from the OBD interface to the user and stores it in a log file. The electronical device is connected to the internet by a communication network for example a cellular network 703. A second car 705 from a different manufacturer also has an OBD interface device 707 installed which, in this example communicates with an electronical device 706 by using a local wireless network connection and is able to communicate with the internet by a cellular network. The electronic device in the second car also has a manufacturer specific software program installed that communicates with the OBD interface and enables data input and output. Data to this OBD interface can be sent by transmission of data packets with manufacturer specific commands. The OBD interface translates the information into data understandable for devices on the internal CAN bus of the car. Data from the CAN bus is received by the OBD interface and sent to the software program at the electronic device which outputs the data at the display or stores it in a database at the electronical device. To enable the second car to perform an action for example to measure and report its engine temperature in case the engine coolant temperature sensor (ECT) in the first car reports a value above a defined limit information from the first cars OBD interface has to be made available to the OBD interface of the second car. To do so AL objects can be used. At the first car in addition to the manufacturer specific OBD interface control program an AL object is located at the electronic device. The AL object is configured to use the log file of the OBD program as its input area and periodically reads its data. The data read can be compared with the result of a previous reading cycle stored in the input section of the AL object or a limit defined in the input section. In case the comparison process reports a value above the limit or a difference that is too high compared to the previous result the AL object looks up the data in the output section associated with the entry in the input section. If the memory address range defined for a peripheral device (e.g. the keyboard) of the electronical device in the second car can directly be reached by the first cars electronical device the data defined in the output section can be a command accepted by the manufacturer specific program at the second car as input command to start measuring the engine temperature and be sent to the output area of the AL object which in this case would be the input area of the manufacturer specific program at the electronical device in the second car. If an input area accepted by the manufacturer specific program in the second car cannot be directly reached the AL objects output section can contain a freely definable command which is sent to and stored by a computer connected with the internet at a defined location. In this case a secondary AL object located at the electronic device of the second car can be used to read and pass the appropriate command to the manufacturer specific program. The input area of this AL objects can be defined as the location at the computer which receives data from the first car. In case data is found by the AL object it can be compared with data in its input section and data from an entry in its output section can be passed to the output area of the AL object which can be defined as input area accepted by the manufacturer specific program. If the OBD interface device directly accepts data packets from the local wireless network connection it is also possible to define the input area of this network interface as output area of the AL object. In other possible embodiments this technique could also be used to, for example acquire diagnostic data from different OBD interfaces and store them in a homogenous, comparable format at a computer connected to the internet or send commands to different OBD interfaces which are accepted as input data by each OBD interface.

FIG. 8 shows an example embodiment of the invention that enables monitoring and control of glucose sensors and insulin pumps from different manufacturers by using AL objects. A first person 800 wears a transmitter 801 which measures glucose levels by a glucose sensor inserted under the skin and has an insulin pump to compensate incorrect glucose levels. The transmitter exchanges information via wireless radio frequency with a monitoring and display device 801. The monitoring and display device is connected to a public communication network 804 (e.g. the internet) and is able to exchange data with a manufacturer specific program at a computer 803 connected to the communication network. A second person 805 wears a transmitter 806 from a different manufacturer also with a glucose sensor and an insulin pump that is connected to an electronical device 807 for example a computer or a smartphone via wireless radio frequency. At the second electronic device a manufacturer specific program is installed that communicates with the transmitter, outputs glucose levels and allows input of data for the insulin pump. Although the second electronic device has access to the public communication network there is no exchange of glucose data with computers on the network. To be able to access glucose data and control insulin levels of the second person by using the monitoring and display device of the first person AL objects can be used. In this case an AL object at the second electronic device could have the output area of the manufacturer specific program (e.g. a log file or a database) defined as its input area, cyclically read the data and compare it with data from a previous reading cycle stored in an entry of its input section. If the data has changed the AL object could look up one or more entries in its output section assigned to the entry in the input section. The entries in the output section could contain data similar to the data sent to the computer by the monitoring and display device of the first person. This data could also be sent to the computer, would appear there as data from a secondary device of the manufacturer of the first glucose monitoring solution and could be received by the monitoring and display device of the first person. To change the insulin level of the second person by using the equipment of the first person a command to change data of an insulin pump from the manufacturer of the equipment of the first person could be sent to a storage location at the computer. An AL object at the electronic device of the second person could have this storage location defined as its input area and cyclically read it. In case data is found it could be compared with entries in the input section followed by lookup of entries in the output section of the AL object. The output section could contain data accepted as input by the manufacturer specific program at the electronical device of the second person and be sent to the output area of the AL object which could be defined as an area accepted as input area of the manufacturer specific program for example the memory address range of a keyboard. Reception of data in such an area would cause the manufacturer specific program to send data to the transmitter and change the insulin level as requested.

While example embodiments of the present invention have been described, it is to be understood that the embodiments described are illustrative only and the scope of the invention is to be defined solely by the appended claims when considered with a full range of equivalents and modifications (e.g., protocols, hardware devices, software platforms etc.) thereto.

1. A method for data transfer between devices that use different communication methods, the method comprising:
reading data output by a first communication method to a component other than the communication method itself;
comparing the data with one or more entries in an input section;
selecting, based on the result of the comparison process, one or more entries in an output section; and
sending the content of selected entries in an output section to an input area of a second communication method.

2. The method of claim 1, further comprising processing data read from an output area by adding data or stripping off parts of the data or storing the data or parts of it and use it for mathematical operations or comparison or combination with previous or subsequent data before comparison with entries in an input section.

3. The method of claim 1 or claim 2, further comprising processing data in selected output sections by adding data or storing the data and use it for mathematical operations or comparison or combination with previous or subsequent data before sending it to an input area of a second communication method.

4. The method of claim 1, further comprising sending data to an input area of a first communication method that causes the communication method to query data from one or more participating devices and send it to the output area of the communication method before reading data from the output area.

5. The method of claim 1, wherein input and/or output areas are memory address ranges of a remote electronical device assigned to input and/or output areas of communication methods of the remote device.

6. The method of claim 1, wherein input and/or output areas are memory address ranges of a local electronical device assigned to input and/or output areas of communication methods of a remote device.

7. The method of claim 1, wherein input and/or output areas are memory address ranges of a local electronic device assigned to input and/or output areas of data interception or data injection techniques.
